(19) United States
(12) Patent Application Publication
(10) Pub. No.: US 2026/0273629 A1
(43) Pub. Date: Sep. 17, 2026

(54) CUTTING INSERT, CUTTING TOOL, AND METHOD FOR MANUFACTURING MACHINED PRODUCT

(71) Applicant: KYOCERA CORPORATION, Kyoto (JP)

(72) Inventor: Yuki YOSHIKI, Kyoto (JP)

(21) Appl. No.: 19/168,817

(22) PCT Filed: Jan. 9, 2024
(86) PCT No.: PCT/JP2024/000094

§ 371 Date: Sep. 25, 2025

(30) Foreign Application Priority Data
Mar. 30, 2023 (JP) 2023-056533

(51) Int. Cl. B23B 27/14; B23C 5/06; B23C 5/20

(52) U.S. Cl. CPC B23B 27/141; B23C 5/06; B23C 5/202; B23B 2200/0442; B23B 2200/128; B23C 2200/0427; B23C 2200/128

(57) ABSTRACT

A cutting insert includes first and second lateral surfaces and a first corner lateral surface. The first lateral surface includes a first recessed portion. The second lateral surface includes a second recessed portion. In a direction parallel to an upper surface, a distance from the first recessed portion to the first corner lateral surface is a first distance, a distance from the second recessed portion to the first corner lateral surface is a second distance, a width of the first recessed portion is a first width, and a width of the second recessed portion is a second width, the first width and the second width are smaller than the first distance and the second distance. In a front view of the first corner lateral surface, the first recessed portion and the second recessed portion are rotationally symmetrically with respect to a center of the first corner lateral surface.

### RELATED APPLICATIONS

The present application is a National Phase of International Application No. PCT/JP 2024/000094 filed Jan. 9, 2024, which claims priority to Japanese Application No. 2023-056533, filed Mar. 30, 2023.

### TECHNICAL FIELD

The present disclosure relates to a cutting insert, a cutting tool, and a method for manufacturing a machined product. Examples of the cutting tool include a rotary tool and a turning tool. Examples of the rotary tool include a milling tool (fraise tool). The milling tool is used in milling processing such as face milling and end milling. Examples of the turning tool include a tool for external turning, a tool for boring, a groove-forming tool, and a cutting-off tool.

### BACKGROUND OF INVENTION

Examples of a known cutting insert used in a cutting tool include cutting inserts described in Patent Documents 1 to 3. The cutting insert described in Patent Document 1 includes a recessed portion at a portion of a lateral surface along a corner of an upper surface for the purpose of facilitating gripping by a robot hand. The cutting insert described in Patent Document 2 includes a recessed portion at a portion of a lateral surface along a corner of an upper surface for the purpose of not widening a crack. The cutting insert described in Patent Document 3 includes a groove at a portion of a lateral surface along a side of an upper surface for the purpose of dividing a chip.

### CITATION LIST

### Patent Literature

Patent Document 1: JP 2022-138402 A
Patent Document 2: Japanese Utility Model Registration No. 2580916
Patent Document 3: JP 2009-107051 A

### SUMMARY

In the present disclosure, a cutting insert includes an upper surface, a lower surface located opposite the upper surface, and a lateral surface connected to the upper surface and the lower surface, and a upper cutting edge located at an intersection of the upper surface and the lateral surface. The upper surface includes a first side, a second side, and a first corner connected to the first side and the second side. The lateral surface includes a first lateral surface connected to the first side, a second lateral surface connected to the second side, and a first corner lateral surface connected to the first corner. The first lateral surface includes a first recessed portion. The second lateral surface includes a second recessed portion. In a direction parallel to the upper surface, a distance from the first recessed portion to the first corner lateral surface is a first distance, a distance from the second recessed portion to the first corner lateral surface is a second distance, a width of the first recessed portion is a first width, and a width of the second recessed portion is a second width. The first width and the second width are smaller than the first distance and the second distance. In a front view of the first corner lateral surface, the first recessed portion and the second recessed portion are located rotationally symmetrically with respect to a center of the first corner lateral surface.

In the present disclosure, a cutting tool includes a holder having a shape extending from a first end to a second end and including a pocket located on a side of the first end, and the cutting insert according to the present disclosure, the cutting insert being located in the pocket.

In the present disclosure, a method for manufacturing a machined product includes rotating the cutting tool according to the present disclosure, bringing the cutting tool into contact with a workpiece, and separating the cutting tool from the workpiece.

In the present disclosure, a method for manufacturing a machined product includes rotating a workpiece, bringing the cutting tool according to the present disclosure into contact with the workpiece that is rotating, and separating the cutting tool from the workpiece.

### BRIEF DESCRIPTION OF THE DRAWINGS

FIG. 1 is a schematic perspective view illustrating a state in which a cutting tool according to an embodiment of the present disclosure is equipped with only one cutting insert.

FIG. 2 is a schematic perspective view illustrating a state in which a cutting insert according to the embodiment of the present disclosure is mounted at a holder.

FIG. 3 is a schematic lateral view illustrating the state in which the cutting insert illustrated in FIG. 2 is mounted at the holder.

FIG. 4 is a cross-sectional view taken along an arrow line IV-IV in FIG. 3.

FIG. 5 is a cross-sectional view illustrating a shape of a cross section of the cutting insert illustrated in FIG. 2, the cross section extending through a first corner lateral surface and being orthogonal to an upper surface.

FIG. 6 is a schematic perspective view illustrating a state in which a cutting insert according to another embodiment of the present disclosure is mounted at a holder.

FIG. 7 is a schematic perspective view illustrating a state in which a cutting insert according to still another embodiment of the present disclosure is mounted at a holder.

FIG. 8 is a schematic lateral view illustrating the state in which the cutting insert illustrated in FIG. 7 is mounted at the holder.

FIG. 9 is a cross-sectional view taken along an arrow line IX-IX in FIG. 8.

FIG. 10 is a schematic perspective view illustrating a state in which a cutting insert according to still another embodiment of the present disclosure is mounted at a holder.

FIG. 11 is a schematic lateral view illustrating the state in which the cutting insert illustrated in FIG. 10 is mounted at the holder.

FIG. 12 is a cross-sectional view taken along an arrow line XII-XII in FIG. 11.

FIG. 13 is a schematic view for describing a method for manufacturing a machined product according to the embodiment of the present disclosure.

FIG. 14 is a schematic view for describing the method for manufacturing the machined product according to the embodiment of the present disclosure.

FIG. 15 is a schematic view for describing the method for manufacturing the machined product according to the embodiment of the present disclosure.

### DESCRIPTION OF EMBODIMENTS

A cutting tool is used in a state of being mounted at a machine tool such as a numerical control (NC) lathe or a machining center. If a cutting insert is replaced in such a machine tool, a workspace in the machine tool is limited, which may complicate work. In particular, in advancing automation of the replacement of the cutting insert, the above-described limited workspace may become a major obstacle.

In the cutting insert described in each of Patent Documents 1 and 2, a recessed portion is provided at a portion of a lateral surface along a corner of an upper surface. In this case, if the cutting insert is mounted at or removed from a pocket of a holder, a claw of a robot hand needs to be inserted into a gap between the recessed portion and the pocket. Therefore, the gripping of the cutting insert may become unstable. In order to facilitate the insertion of the claw of the robot hand, the size of the recessed portion needs to be increased, but in this case, the durability of the cutting insert may be decreased.

In the cutting insert described in Patent Document 3, a groove is provided at a portion of a lateral surface along a side of an upper surface. In this case, the cutting insert is more easily gripped by a robot hand than the cutting inserts described in Patent Documents 1 and 2. However, since the groove in Patent Document 3 is intended to divide a chip, the groove needs to be formed to be long in an up-down direction or a right-left direction in a lateral view, and the durability of the cutting insert may be decreased.

Therefore, a cutting insert that is easy to automatically replace is demanded while durability is enhanced.

A cutting tool, and a method for manufacturing a machined product according to an embodiment of the present disclosure will be described below in detail with reference to the drawings. However, each of the drawings, which will be referred to below, is a simplified representation of only components necessary for description of the embodiment, for convenience of description. Accordingly, the cutting tool according to the embodiment of the present disclosure may be provided with an optional component not illustrated in the referenced drawings. The dimensions of the components in the drawings do not faithfully represent the actual dimensions of the components, the actual dimension ratios of members, or the like.

### Cutting Tool

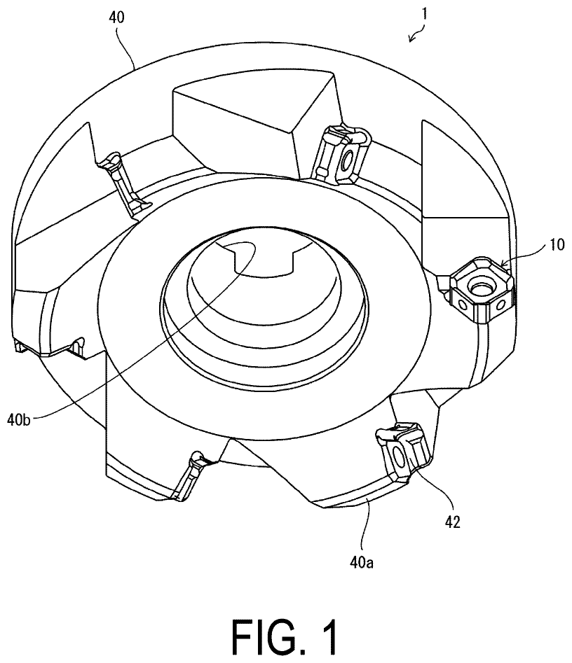

A cutting tool 1 according to the embodiment of the present disclosure will be described with reference to FIG. 1. FIG. 1 is a schematic perspective view illustrating a state in which the cutting tool 1 according to the embodiment of the present disclosure is equipped with only one cutting insert 10. As illustrated in an example in FIG. 1, the cutting tool 1 according to the embodiment of the present disclosure is a tool that is used for machining of a workpiece W (see FIG. 13) and that is rotatable about a rotation axis RS.

The cutting tool 1 may include a holder 40 attached to a spindle of a processing machine such as a milling machine. The holder 40 may have a shape extending from a first end (front end) 40a to a second end (rear end) 40b along the rotation axis RS. The holder 40 may have a cylindrical shape as in the example, or may have a prismatic shape or the like. Examples of the material of the holder 40 include metals such as stainless steel, carbon steel, cast iron, and aluminum alloy.

The holder 40 may include a pocket 42 located on a side of the first end 40a. The pocket 42 may be a recess for attaching the cutting insert 10. A plurality of pockets 42 may be located on an outer peripheral surface of the holder 40.

The plurality of pockets 42 may be located at intervals in a circumferential direction of the outer peripheral surface of the holder 40. In this case, the plurality of pockets 42 may be located at equal intervals in the circumferential direction or at unequal intervals in the circumferential direction. The number of the pockets 42 for each holder 40 may be one.

The cutting tool 1 may include the cutting insert 10 located in the pocket 42 of the holder 40. The cutting insert 10 may be located only in a selected one or more of the plurality of pockets 42 of the holder 40.

### Cutting Insert

### Cutting Insert 10

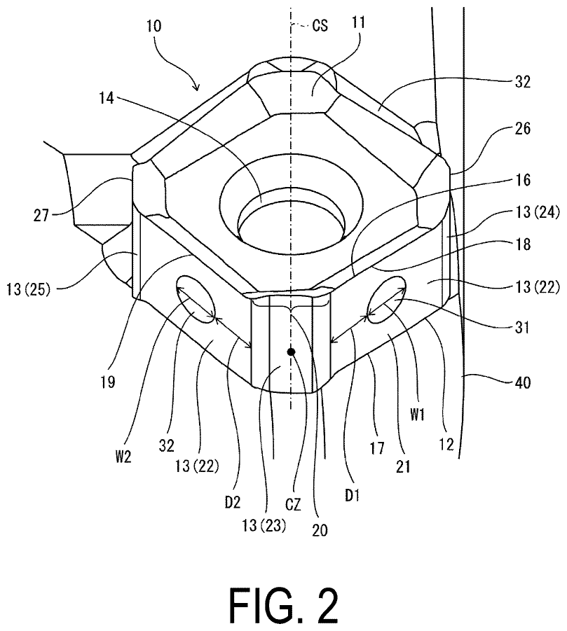

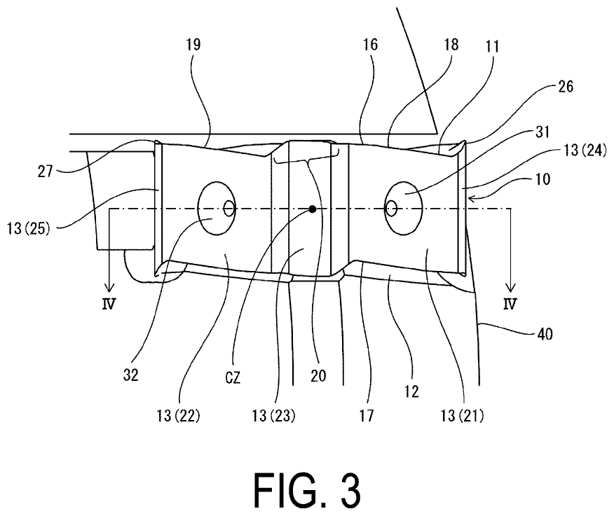

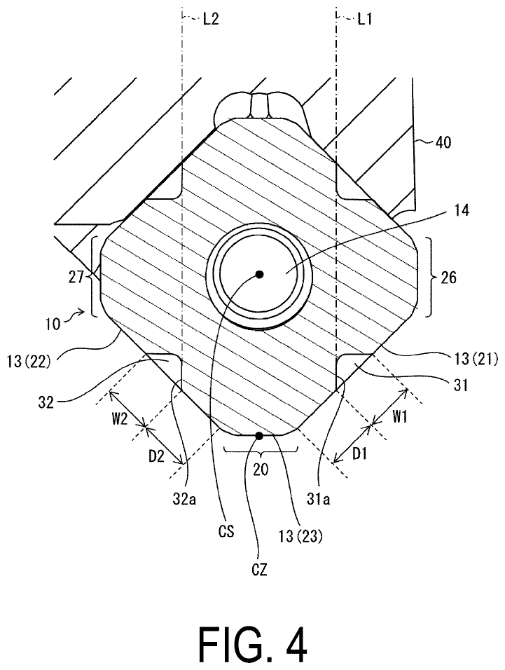

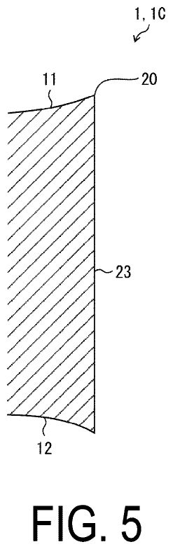

The cutting insert 10 according to the embodiment of the present disclosure will be described with reference to FIGS. 2 to 5. FIG. 2 is a schematic perspective view illustrating a state in which the cutting insert 10 according to the embodiment of the present disclosure is mounted at the holder 40. FIG. 3 is a schematic lateral view illustrating the state in which the cutting insert 10 illustrated in FIG. 2 is mounted at the holder 40. FIG. 4 is a cross-sectional view taken along an arrow line IV-IV in FIG. 3. FIG. 5 is a cross-sectional view illustrating a shape of a cross section of the cutting insert 10 illustrated in FIG. 2, the cross section extending through a first corner lateral surface 23 and being orthogonal to an upper surface 11.

The cutting insert 10 according to the embodiment of the present disclosure is a component of a cutting tool used for machining of the workpiece W (see FIG. 13) made of a metal material or the like. Examples of the machining of the workpiece W include shoulder machining, grooving, R machining, and profiling.

As illustrated in FIGS. 2, 3 and 4, the cutting insert 10 may include the upper surface 11 and a lower surface 12 located on the opposite side of the upper surface 11. Each of the upper surface 11 and the lower surface 12 may have a polygonal shape, for example, an octagonal shape. In other words, the cutting insert 10 may have a polygonal plate shape, for example, an octagonal plate shape. Each of the upper surface 11 and the lower surface 12 may have a polygonal shape other than an octagonal shape, for example, a triangular shape, a quadrilateral shape, or the like. In other words, the cutting insert 10 may have a polygonal plate shape other than an octagonal plate shape, for example, a triangular plate shape, a quadrilateral plate shape, or the like. The polygonal shape is not limited strictly to a shape of a polygon.

Each of the upper surface 11 and the lower surface 12 may have a rotationally symmetrical shape at a constant angle with respect to an insert central axis CS. The upper surface 11 and the lower surface 12 may be shaped such that the front and back sides are reversed and symmetrical. In other words, the cutting insert 10 may have a rotationally symmetrical shape at a constant angle with respect to the insert central axis CS or may be shaped such that the front and back sides are reversed and symmetrical.

The cutting insert 10 may include a lateral surface 13 located between the upper surface 11 and the lower surface 12. The lateral surface 13 may be connected to the upper surface 11 and the lower surface 12. The lateral surface 13 may function as a flank face and may be parallel to the insert central axis CS.

The cutting insert 10 may include a mounting hole 14 extending therethrough from the upper surface 11 to the lower surface 12. The central axis of the mounting hole 14 may coincide with the insert central axis CS.

The cutting insert 10 may include a upper cutting edge 16 located at the intersection of the upper surface 11 and the lateral surface 13. The cutting insert 10 may include a lower cutting edge 17 located at the intersection of the lower surface 12 and the lateral surface 13. In other words, the cutting insert 10 may be a double-sided insert provided with the upper cutting edge 16 and the lower cutting edge 17.

The upper surface 11 may include a first side 18, a second side 19, and a first corner 20 connected to the first side 18 and the second side 19. The first side 18 may have a linear shape when viewed from directly above or may come close to the lower surface 12 with distance from the first corner 20 in the lateral view. The second side 19 may have a linear shape when viewed from directly above or may come close to the lower surface 12 with distance from the first corner 20 in the lateral view.

The lateral surface 13 may include a first lateral surface 21 connected to the first side 18, a second lateral surface 22 connected to the second side 19, and the first corner lateral surface 23 connected to the first corner 20. The first lateral surface 21 may include a first recessed portion 31, and the second lateral surface 22 may include a second recessed portion 32.

In a front view of the first lateral surface 21, the shape of the first recessed portion 31 may be circular, elliptical, or polygonal. In a front view of the second lateral surface 22, the shape of the second recessed portion 32 may be circular, elliptical, or polygonal. The shape of the inside of each of the first recessed portion 31 and the second recessed portion 32 may be a cone shape, a cone shape with a rounded apex, a rectangular parallelepiped shape, or the like.

In the above configuration, the first recessed portion 31 is provided on the first lateral surface 21, and the second recessed portion 32 is provided on the second lateral surface 22. Thus, if the cutting insert 10 is replaced, claws of a robot hand of a device such as a robot arm used for the replacement can be inserted into the first recessed portion 31 and the second recessed portion 32 to grip the cutting insert 10. Unlike a configuration in which a recessed portion is provided in a corner portion of a lateral surface, a claw does not need to be inserted into a gap between the recessed portion and the pocket, and thus the cutting insert is easily gripped by the robot hand.

As illustrated in FIG. 2, in a direction parallel to the upper surface 11, if the distance from the first recessed portion 31 to the first corner lateral surface 23 is a first distance D1, the distance from the second recessed portion 32 to the first corner lateral surface 23 is a second distance D2, the width of the first recessed portion 31 is a first width W1, and the width of the second recessed portion 32 is a second width W2, the cutting insert 10 may have a configuration in which the first width W1 and the second width W2 are smaller than the first distance D1 and the second distance D2.

With such a configuration, the possibility of a decrease in the durability of the cutting insert 10 can be decreased while the first recessed portion 31 and the second recessed portion 32 are provided.

The first distance D1 may be the shortest distance between the first recessed portion 31 and the first corner lateral surface 23 in the direction parallel to the upper surface 11. The second distance D2 may be the shortest distance between the second recessed portion 32 and the first corner lateral surface 23 in the direction parallel to the upper surface 11.

In the cutting insert 10, in a front view of the first corner lateral surface 23, the first recessed portion 31 and the second recessed portion 32 may be located rotationally symmetrically with respect to a center CZ (indicated by a dot in the drawing) of the first corner lateral surface 23.

With such a configuration, if the cutting insert 10 is an insert that can be used with the front and back sides reversed, the positions of the first recessed portion 31 and the second recessed portion 32 do not change even if the cutting insert 10 is mounted with the front and back sides reversed. This simplifies work of gripping the cutting insert 10 by the robot hand and simplifies motion of the device, thereby avoiding complication of the device.

In the cutting insert 10, the first recessed portion 31 and the second recessed portion 32 may be provided at the same position in an up-down direction from the upper surface 11 toward the lower surface 12. With such a configuration, if the cutting insert 10 has a rotationally symmetrical shape at a constant angle with respect to the insert central axis CS, the positions of the first recessed portion 31 and the second recessed portion 32 do not change even if the cutting insert 10 is rotated by the constant angle and mounted. This simplifies work of gripping the cutting insert 10 by the robot hand and simplifies motion of the device, thereby avoiding complication of the device.

If the cutting insert 10 has a rotationally symmetrical shape at a constant angle with respect to the insert central axis CS, the first recessed portion 31 and the second recessed portion 32 are formed, among the lateral surfaces except the corner lateral surfaces, in the lateral surfaces adjacent with the corner lateral surface interposed therebetween.

As illustrated in FIG. 4, the first recessed portion 31 includes a first wall surface 31a located on a side of the second recessed portion 32, and the second recessed portion 32 includes a second wall surface 32a located on a side of the first recessed portion 31. In the cross section parallel to the upper surface 11, an extension line L1 of the first wall surface 31a and an extension line L2 of the second wall surface 32a may be parallel to each other or may be inclined to intersect each other on a side where the center of the upper surface 11 is located. As described above, the center of the upper surface 11 may be the insert central axis CS.

If the cutting insert 10 is gripped by the robot hand, the claws of the robot hand are inserted into the first recessed portion 31 and the second recessed portion 32 from the front of the first corner lateral surface 23 and brought into contact with the first wall surface 31a and the second wall surface 32a to hold the cutting insert 10. With the above configuration, since the first wall surface 31a and the second wall surface 32a with which the claws are brought into contact are parallel to each other or are inclined to approach each other toward the side where the center of the upper surface 11 is located, the claws can easily grip the first wall surface 31a and the second wall surface 32a.

As illustrated in FIG. 5, in the cutting insert 10, the first corner lateral surface 23 may have a linear shape or a protruding shape in the cross section that extends through the first corner lateral surface 23 and that is orthogonal to the upper surface 11. That is, no recessed portion into which a claw of the robot hand can be inserted is formed in the first corner lateral surface 23.

With such a configuration, the possibility of a decrease in the durability of the cutting insert 10 can be decreased.

In the cutting insert 10, the upper surface 11 may further include a second corner 26 connected to a different side of the first side 18 from a side where the first corner 20 is connected, and a third corner 27 connected to a different side of the second side 19 from a side where the first corner 20 is connected. The lateral surface 13 may include a second corner lateral surface 24 connected to the second corner 26 and a third corner lateral surface 25 connected to the third corner 27.

### Cutting Insert 10A

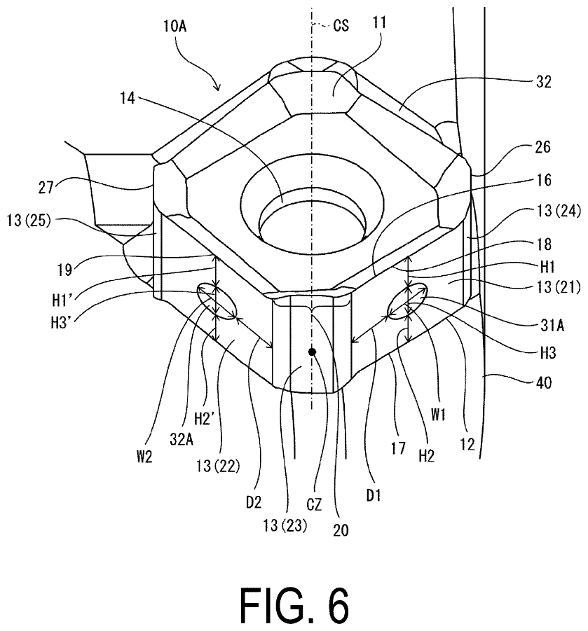

FIG. 6 is a schematic perspective view illustrating a state in which a cutting insert 10A according to another embodiment of the present disclosure is mounted at a holder 40. For convenience of description, a member having the same function as a member described in the above embodiment is denoted by the same reference sign, and the description of the above embodiment is incorporated.

As illustrated in FIG. 6, in an up-down direction from an upper surface 11 toward a lower surface 12, if the width from a first recessed portion 31A to the upper surface 11 is a first height H1, the width from of the first recessed portion 31A to the lower surface 12 is a second height H2, and the width of the first recessed portion 31A is a third height H3, the cutting insert 10A may have a configuration in which the third height H3 is smaller than the first height H1 and the second height H2.

With such a configuration, while the cutting insert 10A is provided with the first recessed portion 31A, the distance between the first recessed portion 31A and the upper surface 11 where a upper cutting edge 16 is located at the intersection with a lateral surface 13 and the distance between the first recessed portion 31A and the lower surface 12 where a lower cutting edge 17 is located at the intersection with the lateral surface 13 can be maintained, and the strengths of the upper cutting edge 16 and the lower cutting edge 17 can be enhanced.

As illustrated in FIG. 6, in the up-down direction from the upper surface 11 toward the lower surface 12, if the width from a second recessed portion 32A to the upper surface 11 is a first height H1′, the width from the second recessed portion 32A to the lower surface 12 is a second height H2′, and the width of the second recessed portion 32A is a third height H3′, the cutting insert 10A may have a configuration in which the third height H3′ is smaller than the first height H1′ and the second height H2′.

With such a configuration, while the second recessed portion 32A is provided, the distance between the second recessed portion 32A and the upper surface 11 where a upper cutting edge 16 is located at the intersection with a lateral surface 13 and the distance between the second recessed portion 32A and the lower surface 12 where a lower cutting edge 17 is located at the intersection with the lateral surface 13 can be maintained, and the strengths of the upper cutting edge 16 and lower cutting edge 17 can be enhanced.

### Cutting Insert 10B

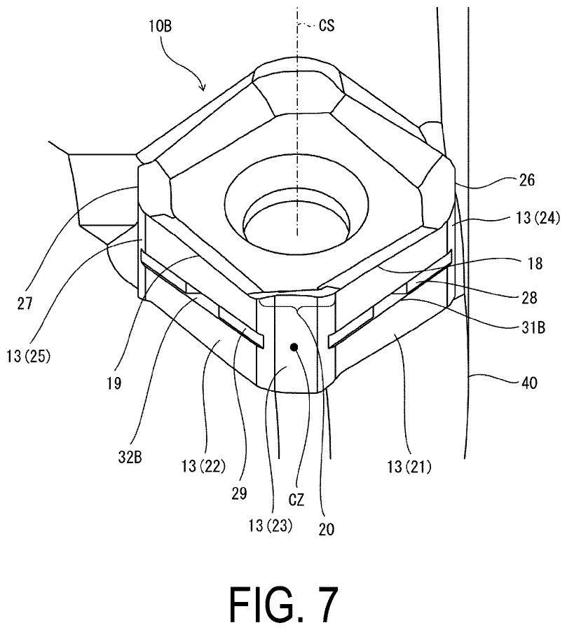

FIG. 7 is a schematic perspective view illustrating a state in which a cutting insert 10B according to still another embodiment of the present disclosure is mounted at a holder 40.

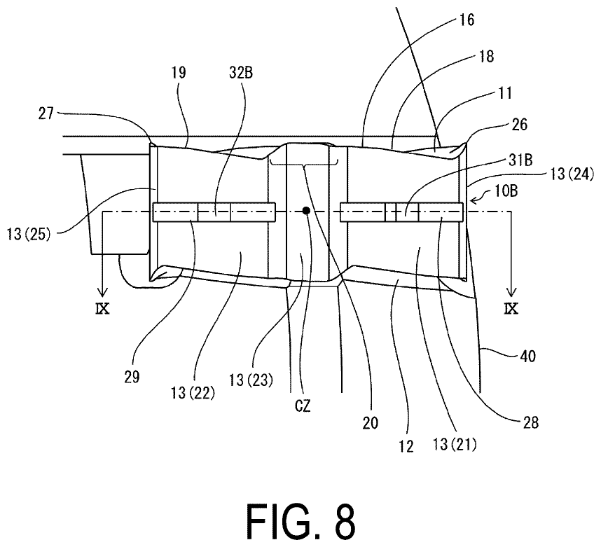

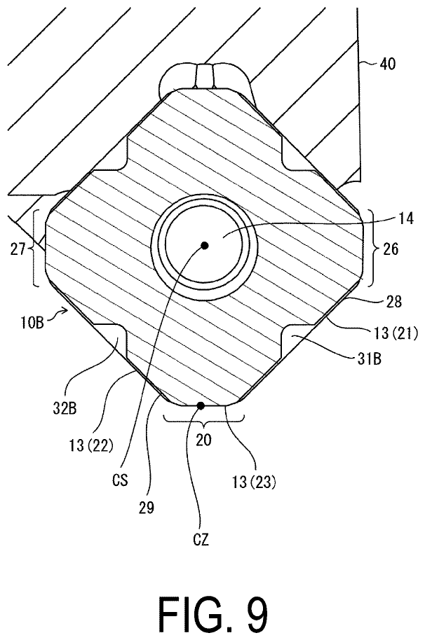

FIG. 8 is a schematic lateral view illustrating the state in which the cutting insert 10B illustrated in FIG. 7 is mounted at the holder 40. FIG. 9 is a cross-sectional view taken along an arrow line IX-IX in FIG. 8.

As illustrated in FIG. 7, the cutting insert 10B may include, on a first lateral surface 21, a first groove portion 28 extending in a direction parallel to an upper surface 11. The cutting insert 10B may include, on a second lateral surface 22, a second groove portion 29 extending in the direction parallel to the upper surface 11. The first groove portion 28 and the second groove portion 29 may be located at the centers of the first lateral surface 21 and the second lateral surface 22 in an up-down direction, respectively.

In the cutting insert 10B, a first recessed portion 31B may be located in the first groove portion 28, and a second recessed portion 32B may be located in the second groove portion 29. The first recessed portion 31B and the second recessed portion 32B may be located at the centers of the first groove portion 28 and the second groove portion 29 in the direction parallel to the upper surface 11, respectively.

In such a configuration, the first groove portion 28 and the second groove portion 29 function as guide grooves for guiding claws of a robot hand. This facilitates insertion of the claws of the robot hand into the first recessed portion 31 and the second recessed portion 32.

Here, an end portion of the first groove portion 28 on a side of a first corner lateral surface 23 may reach the first corner lateral surface 23 and an end portion of the first groove portion 28 on a side of a second corner lateral surface 24 may reach the second corner lateral surface 24. An end portion of the second groove portion 29 on a side of the first corner lateral surface 23 may reach the first corner lateral surface 23, and an end portion of the second groove portion 29 on a side of a third corner lateral surface 25 may reach the third corner lateral surface 25.

With such a configuration, if the cutting insert 10B is gripped by the robot hand from the front of the first corner lateral surface 23, the claws of the robot hand can be guided into the first groove portion 28 and the second groove portion 29 from the second corner lateral surface 24 and the third corner lateral surface 25. This can further facilitate insertion of the claws of the robot hand into the first recessed portion 31B and the second recessed portion 32B.

### Cutting Insert 10C

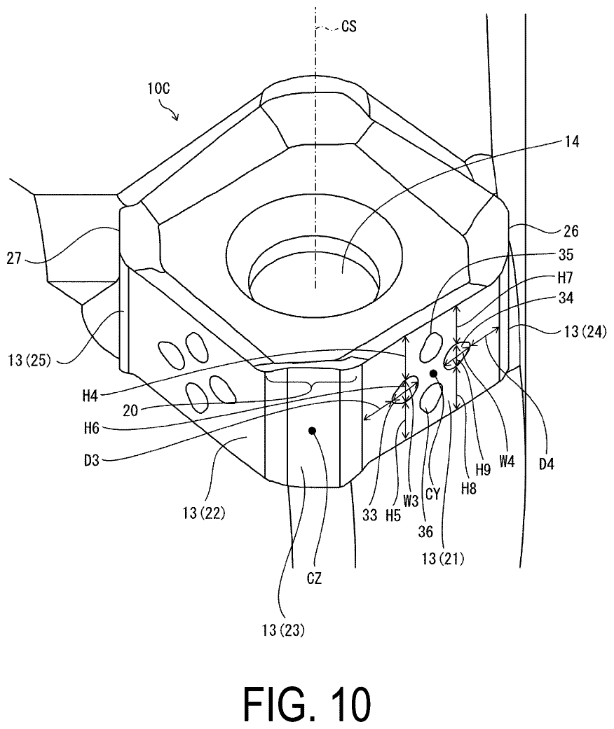

FIG. 10 is a schematic perspective view illustrating a state in which a cutting insert 10C according to still another embodiment of the present disclosure is mounted at a holder 40.

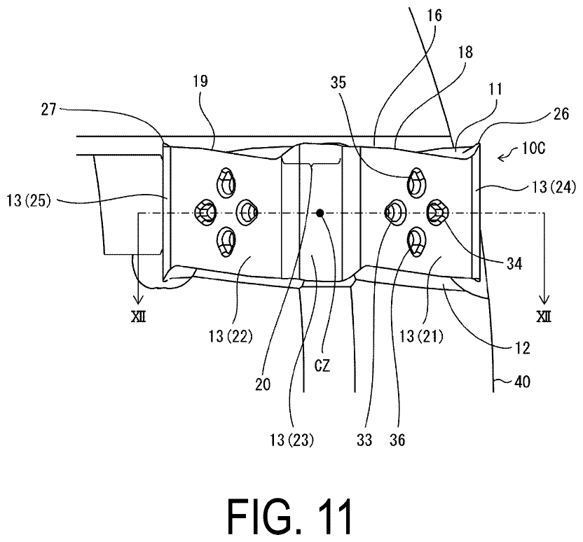

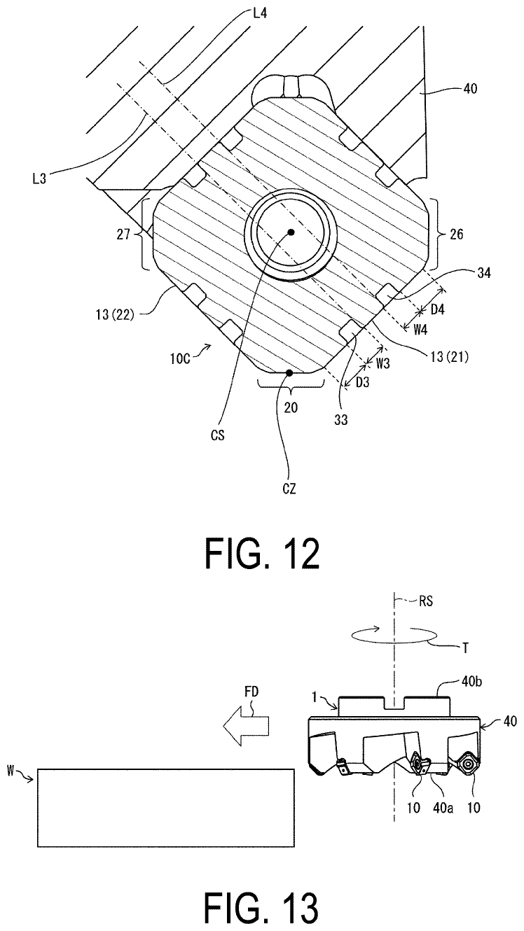

FIG. 11 is a schematic lateral view illustrating the state in which the cutting insert 10C illustrated in FIG. 10 is mounted at the holder 40. FIG. 12 is a cross-sectional view taken along an arrow line XII-XII in FIG. 11.

As illustrated in FIGS. 10 and 11, a first lateral surface 21 may include a third recessed portion 33 and a fourth recessed portion 34 located closer to a second corner lateral surface 24 than the third recessed portion 33 is to the second corner lateral surface 24. In a direction parallel to an upper surface 11, if the distance from the third recessed portion 33 to a first corner lateral surface 23 is a third distance D3, the distance from the fourth recessed portion 34 to the second corner lateral surface 24 is a fourth distance D4, the width of the third recessed portion 33 is a third width W3, and the width of the fourth recessed portion 34 is a fourth width W4, the third width W3 and the fourth width W4 may be configured to be smaller than the third distance D3 and the fourth distance D4.

With such a configuration, the possibility of a decrease in the durability of the cutting insert 10C can be decreased while the first lateral surface 21 is provided with the third recessed portion 33 and the fourth recessed portion 34.

The third distance D3 may be the shortest distance between the third recessed portion 33 and the first corner lateral surface 23 in the direction parallel to the upper surface 11. The fourth distance D4 may be the shortest distance between the fourth recessed portion 34 and the second corner lateral surface 24 in the direction parallel to the upper surface 11.

In the cutting insert 10C, in a front view the first lateral surface 21, the third recessed portion 33 and the fourth recessed portion 34 may be located rotationally symmetrically with respect to a center CY (indicated by a dot in the drawing) of the first lateral surface 21.

With such a configuration, if the cutting insert 10C is an insert that can be used with the front and back sides reversed, the positions of the third recessed portion 33 and the fourth recessed portion 34 do not change even if the cutting insert 10C is mounted with the front and back sides reversed. This simplifies the work of gripping the cutting insert 10C by a robot hand and simplifies motion of the device, thereby avoiding complication of the device.

In the cutting insert 10C, the third recessed portion 33 and the fourth recessed portion 34 may be provided at the same position in an up-down direction from the upper surface 11 toward a lower surface 12. With such a configuration, if the cutting insert 10C has a rotationally symmetrical shape at a constant angle with respect to an insert center axis CS, the positions of the third recessed portion 33 and the fourth recessed portion 34 do not change even if the cutting insert 10C is rotated by the constant angle and mounted. This simplifies work of gripping the cutting insert 10C by the robot hand and simplifies motion of the device, thereby avoiding complication of the device.

If the cutting insert 10C has a rotationally symmetrical shape at a constant angle with respect to the insert central axis CS, the third recessed portion 33 and the fourth recessed portion 34 may be formed at each of the lateral surfaces except the corner lateral surfaces.

In the up-down direction from the upper surface 11 toward the lower surface 12, if the width from the third recessed portion 33 to the upper surface 11 is a fourth height H4, the width from the third recessed portion 33 to the lower surface 12 is a fifth height H5, and the width of the third recessed portion 33 is a sixth height H6, the cutting insert 10C may have a configuration in which the sixth height H6 is smaller than the fourth height H4 and the fifth height H5.

With such a configuration, while the cutting insert 10C is provided with the third recessed portion 33, the distance between the third recessed portion 33 and the upper surface 11 where a upper cutting edge 16 is located at the intersection with a lateral surface 13 and the distance between the third recessed portion 33 and the lower surface 12 where a lower cutting edge 17 is located at the intersection with the lateral surface 13 can be maintained, and the strengths of the upper cutting edge 16 and the lower cutting edge 17 can be enhanced.

In the up-down direction from the upper surface 11 toward the lower surface 12, if the width from the fourth recessed portion 34 to the upper surface 11 is a seventh height H7, the width from the fourth recessed portion 34 to the lower surface 12 is an eighth height H8, and the width of the fourth recessed portion 34 is a ninth height H9, the cutting insert 10C may have a configuration in which the ninth height H9 is smaller than the seventh height H7 and the eighth height H8.

With such a configuration, while the fourth recessed portion 34 is provided, the distance between the fourth recessed portion 34 and the upper surface 11 where the upper cutting edge 16 is located at the intersection with the lateral surface 13 and the distance between the fourth recessed portion 34 and the lower surface 12 where the lower cutting edge 17 is located at the intersection with the lateral surface 13 can be maintained, and the strengths of the upper cutting edge 16 and the lower cutting edge 17 can be enhanced.

As illustrated in FIG. 5, in the cutting insert 10C, the first corner lateral surface 23 may have a linear shape or a protruding shape in the cross section that extends through the first corner lateral surface 23 and that is orthogonal to the upper surface 11. That is, no recessed portion into which a claw of the robot hand can be inserted is formed in the first corner lateral surface 23.

With such a configuration, the possibility of a decrease in the durability of the cutting insert 10 can be decreased.

As illustrated in FIG. 12, the third recessed portion 33 includes a third wall surface 33a located on a side of the fourth recessed portion 34, and the fourth recessed portion 34 includes a fourth wall surface 34a located on a side of the third recessed portion 33. In a cross section parallel to the upper surface 11, an extension line L3 of the third wall surface 33a and an extension line L4 of the fourth wall surface 34a may be parallel to each other or may be inclined to intersect each other on a side where the center of the upper surface 11 is located. As described above, the center of the upper surface 11 may be the insert central axis CS.

If the cutting insert 10C is gripped by the robot hand, claws of the robot hand are inserted into the third recessed portion 33 and the fourth recessed portion 34 from the front of the first lateral surface 21 and brought into contact with the third wall surface 33a and the fourth wall surface 34a to hold the cutting insert 10C. With the above configuration, since the third wall surface 33a and the fourth wall surface 34a with which the claws are brought into contact are parallel to each other or inclined to approach each other toward the side where the center of the upper surface 11 is located, the claws can easily grip the third wall surface 33a and the fourth wall surface 34a.

The above configuration is effective in holding the cutting insert 10C by narrowing the gap between the pair of claws of the robot hand if the cutting insert 10C is gripped by the robot hand. On the other hand, for example, if the robot hand grips the cutting insert 10C by widening the gap between the pair of claws of the robot hand and pressing the pair of claws against the third recessed portion 33 and the fourth recessed portion 34 to grip the cutting insert 10C, the extension line L3 of the third wall surface 33a and the extension line L4 of the fourth wall surface 34a may be inclined to be separated from each other at the side where the center of the upper surface 11 is located in the cross section parallel to the upper surface 11.

In the cutting insert 10C, the first lateral surface 21 may include a fifth recessed portion 35 and a sixth recessed portion 36 located closer to the lower surface 12 than the fifth recessed portion 35 is to the lower surface 12. In the front view of the first lateral surface 21, the fifth recessed portion 35 and the sixth recessed portion 36 may be located rotationally symmetrically with respect to the center CY of the first lateral surface 21.

In the cutting insert 10C, the second lateral surface 22 may include a third recessed portion 33, a fourth recessed portion 34, a fifth recessed portion 35, and a sixth recessed portion 36. If the first corner lateral surface 23 is viewed from the front, the third recessed portion 33 to the sixth recessed portion 36 located in the first lateral surface 21 and the third recessed portion 33 to the sixth recessed portion 36 located in the second lateral surface 22 may be located rotationally symmetrically with respect to a center CZ of the first corner lateral surface 23. If the cutting insert 10C has a rotationally symmetrical shape, the third recessed portion 33 to the sixth recessed portion 36 may be formed in each of the lateral surfaces except the corner lateral surfaces.

### Method for Manufacturing Machined Product

A method for manufacturing a machined product according to the embodiment of the present disclosure will be described with reference to FIGS. 13 to 15. FIGS. 13 to 15 are schematic views for describing the method for manufacturing the machined product according to the embodiment of the present disclosure. FIGS. 13 to 15 illustrate the cutting tool 1 according to the embodiment of the present disclosure.

As in examples illustrated in FIGS. 13 to 15, the method for manufacturing the machined product according to the embodiment of the present disclosure is a method for manufacturing a machined product M by machining the workpiece W using the cutting tool 1 and may include a first step, a second step, and a third step. The first step is a step of rotating cutting tool 1. The second step is a step of bringing the cutting tool 1, which is rotating, into contact with the workpiece W. The third step is a step of separating the cutting tool 1 from the workpiece W. Here, examples of the material of the workpiece W include aluminum alloy, stainless steel, carbon steel, alloy steel, cast iron, and non-ferrous metal. The specific content of the method for manufacturing the machined product according to the embodiment of the present disclosure is as follows.

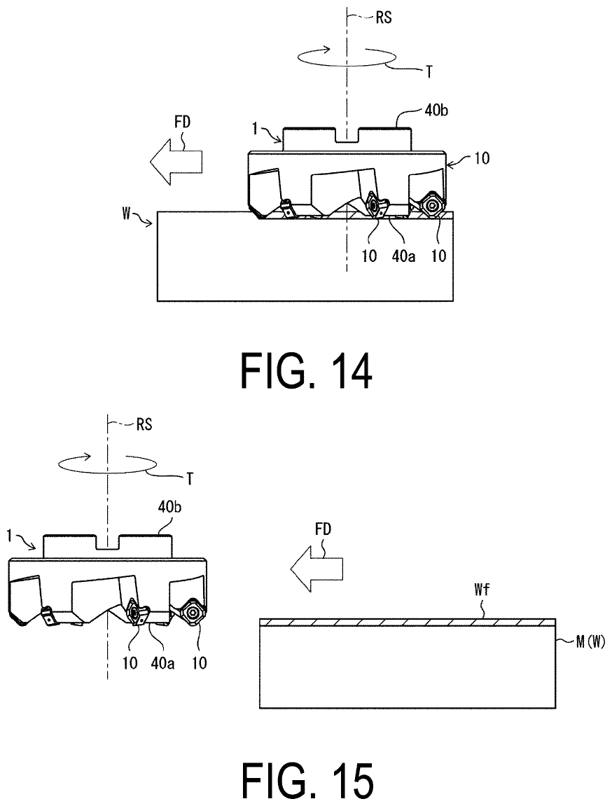

As in the examples illustrated in FIGS. 13 and 14, the cutting tool 1 is moved in a direction of an arrow FD to approach the workpiece W while being rotated in a rotation direction T. The cutting insert 10 of the cutting tool 1, which is rotating, is moved in the direction of the arrow FD while being brought into contact with the workpiece W. Thus, machining of the workpiece W is performed by the cutting tool 1, and a machined surface Wf is formed on the workpiece as in the example illustrated in FIG. 15.

Subsequently, as in the example illustrated in FIG. 15, the cutting tool 1 is further moved in the direction of the arrow FD to be separated from the workpiece W. This completes the machining of the workpiece W and enables the machined product M, which is the workpiece W after the machining, to be manufactured. If the machining is continued, the cutting insert 10 of the cutting tool 1 is only required to be repeatedly brought into contact with a different portion of the workpiece W while the cutting tool 1 is being rotated.

As described above, the cutting tool 1 includes a cutting insert that is easy to automatically replace while enhancing durability. This makes it possible to reduce manufacturing cost while increasing productivity.

Although FIGS. 13 and 15 illustrate the manufacturing method of bringing the cutting tool 1 close to the workpiece W, the cutting tool and the workpiece W is only required to be brought relatively close to each other. Therefore, although not illustrated, the workpiece may be brought close to the cutting tool, for example. In this respect, the same procedure is performed in separating the cutting tool from the workpiece. That is, the method for manufacturing the machined product according to the present disclosure is a method for manufacturing a machined product by machining a workpiece using a cutting tool, and may include a step of rotating the workpiece, a step of bringing the cutting tool according to the present disclosure into contact with the rotating workpiece, and a step of separating the cutting tool according to the present disclosure from the workpiece.

Although the cutting tool 1 has been described as an example in the embodiments of the present disclosure, as described above, examples of the cutting tool include a rotary tool and a turning tool. Examples of the rotary tool include a milling tool (fraise tool). The milling tool is used in milling processing such as face milling and end milling. Examples of the turning tool include a tool for external turning, a tool for boring, a groove-forming tool, and a cutting-off tool.

The invention according to the present disclosure has been described above based on the various drawings and embodiments. However, the invention according to the present disclosure is not limited to the above-described embodiments. In other words, the embodiments of the invention according to the present disclosure can be modified in various ways within the scope described in the present disclosure, and embodiments obtained by appropriately combining the disclosed technical means are also included in the technical scope of the invention according to the present disclosure. In other words, it should be noted that a person skilled in the art can easily make various variations or modifications based on the present disclosure. Note that these variations or modifications are included within the scope of the present disclosure.

1. A cutting insert comprising:
an upper surface;
a lower surface located opposite the upper surface;
a lateral surface connected to the upper surface and the lower surface; and
a upper cutting edge located at an intersection of the upper surface and the lateral surface,
wherein
the upper surface comprises:
a first side;
a second side; and
a first corner connected to the first side and the second side,
the lateral surface comprises:
a first lateral surface connected to the first side;
a second lateral surface connected to the second side; and
a first corner lateral surface connected to the first corner,
the first lateral surface comprises a first recessed portion,
the second lateral surface comprises a second recessed portion,
in a direction parallel to the upper surface,
a distance from the first recessed portion to the first corner lateral surface is a first distance,
a distance from the second recessed portion to the first corner lateral surface is a second distance,
a width of the first recessed portion is a first width, and
a width of the second recessed portion is a second width,
each of the first width and the second width is smaller than each of the first distance and the second distance, and
in a front view of the first corner lateral surface, the first recessed portion and the second recessed portion are located rotationally symmetrically with respect to a center of the first corner lateral surface.

2. The cutting insert according to claim 1, wherein
a virtual line through a center of the upper surface and a center of the lower surface is a central axis,
in direction along to the central axis, a height from the lower surface to the first recessed portion is same as a height from the lower surface to the second recessed portion.

3. The cutting insert according to claim 1, wherein
a virtual line through a center of the upper surface and a center of the lower surface is a central axis,
in direction along the central axis
a width from the first recessed portion to the upper surface is a first height,
a width from the first recessed portion to the lower surface is a second height, and
a width of the first recessed portion is a third height, and
the third height is smaller than the first height and the second height.

4. The cutting insert according to claim 1, wherein
a virtual line through a center of the upper surface and a center of the lower surface is a central axis, and
the first corner lateral surface has a linear shape or a protruding shape in a cross section that extends through the first corner lateral surface and that is parallel to the central axis.

5. The cutting insert according to claim 1, wherein
the first recessed portion comprises a first wall surface located on a side of the second recessed portion,
the second recessed portion comprises a second wall surface located on a side of the first recessed portion, and
in a cross section parallel to the upper surface, an extension line of the first wall surface and an extension line of the second wall surface are parallel to each other or inclined to intersect each other on a side where a center of the upper surface is located.

6. A cutting insert comprising:
an upper surface;
a lower surface located opposite the upper surface;
a lateral surface connected to the upper surface and the lower surface; and
an upper cutting edge located at an intersection of the upper surface and the lateral surface, wherein
the upper surface comprises:
a first side;
a second side;
a first corner connected to the first side and the second side; and
a second corner connected to a different side of the first side from a side where the first corner is connected,
the lateral surface comprises:
a first lateral surface connected to the first side;
a second lateral surface connected to the second side;
a first corner lateral surface connected to the first corner; and
a second corner lateral surface connected to the second corner,
the first lateral surface comprises:
a third recessed portion; and
a fourth recessed portion located closer to the second corner lateral surface than the third recessed portion is to the second corner lateral surface,
in a direction parallel to the upper surface,
a distance from the third recessed portion to the first corner lateral surface is a third distance,
a distance from the fourth recessed portion to the second corner lateral surface is a fourth distance,
a width of the third recessed portion is a third width, and
a width of the fourth recessed portion is a fourth width,
each of the third width and the fourth width is smaller than each of the third distance and the fourth distance, and
in a front view of the first lateral surface, the third recessed portion and the fourth recessed portion are located rotationally symmetrically with respect to a center of the first lateral surface.

7. The cutting insert according to claim 6, wherein
a virtual line through a center of the upper surface and a center of the lower surface is a central axis,
in direction along to the central axis, a height from the lower surface to the third recessed portion is same as a height from the lower surface to the fourth recessed portion.

8. The cutting insert according to claim wherein
a virtual line through a center of the upper surface and a center of the lower surface is a central axis,
in direction along to the central axis,
a width from the third recessed portion to the upper surface is a fourth height,
a width from the third recessed portion to the lower surface is a fifth height, and
a width of the third recessed portion is a sixth height, and
the sixth height is smaller than the fourth height and the fifth height.

9. The cutting insert according to claim 6, wherein
a virtual line through a center of the upper surface and a center of the lower surface is a central axis,
the first corner lateral surface has a linear shape or a protruding shape in a cross section that extends through the first corner lateral surface and that is parallel to the central axis, and
the second corner lateral surface has a linear shape or a protruding shape in a cross section that extends through the second corner lateral surface and that is parallel to the central. axis.

10. The cutting insert according to claim 6, wherein
the third recessed portion comprises a third wall surface located on a side of the fourth recessed portion,
the fourth recessed portion comprises a fourth wall surface located on a side of the third recessed portion, and
in a cross section parallel to the upper surface, an extension line of the third wall surface and an extension line of the fourth wall surface are parallel to each other or inclined to intersect each other on a side where a center of the upper surface is located.

11. A cutting tool comprising:
a holder having a shape extending from a first end to a second end and comprising a pocket located on a side of the first end; and
the cutting insert according to claim 1, the cutting insert being located in the pocket.

12. A method for manufacturing a machined product, the method comprising:
rotating the cutting tool according to claim 11;
bringing the cutting tool into contact with a workpiece; and
separating the cutting tool from the workpiece.

13. A method for manufacturing a machined product, the method comprising:
rotating a workpiece;
bringing the cutting tool according to claim 11 into contact with the workpiece that is rotating; and
separating the cutting tool from the workpiece.
